(19) United States
(12) Patent Application Publication
(10) Pub. No.: US 2014/0289361 A1
(43) Pub. Date: Sep. 25, 2014

(54) COMMUNICATION SYSTEM, INFORMATION PROCESSING APPARATUS, AND NON-TRANSITORY COMPUTER READABLE MEDIUM

(71) Applicant: FUJI XEROX CO., LTD., Tokyo (JP)

(72) Inventor: Rie NAKAZATO, Kanagawa (JP)

(73) Assignee: FUJI XEROX CO., LTD., Tokyo (JP)

(21) Appl. No.: 14/039,590

(22) Filed: Sep. 27, 2013

(30) Foreign Application Priority Data
Mar. 22, 2013 (JP) 2013-060134

(51) Int. Cl. H04L 29/08

(52) U.S. Cl. CPC H04L 67/02
USPC 709/217

(57) ABSTRACT

A communication system includes an information processing apparatus and a relay apparatus. The information processing apparatus generates, when performing processing on first information which has been obtained, second information and transmits the generated second information to the relay apparatus. The second information represents an estimated time period taken for processing the first information or a processing state of the first information. The relay apparatus obtains the second information which has been transmitted by the information processing apparatus and outputs the obtained second information to a predetermined information storage apparatus.

### CROSS-REFERENCE TO RELATED APPLICATIONS

This application is based on and claims priority under 35 USC 119 from Japanese Patent Application No. 2013-060134 filed Mar. 22, 2013.

### BACKGROUND

### Technical Field

The present invention relates to a communication system, an information processing apparatus, and a non-transitory computer readable medium.

### SUMMARY

According to an aspect of the invention, there is provided a communication system including an information processing apparatus and a relay apparatus. The information processing apparatus generates, when performing processing on first information which has been obtained, second information and transmits the generated second information to the relay apparatus. The second information represents an estimated time period taken for processing the first information or a processing state of the first information. The relay apparatus obtains the second information which has been transmitted by the information processing apparatus and outputs the obtained second information to a predetermined information storage apparatus.

### BRIEF DESCRIPTION OF THE DRAWINGS

An exemplary embodiment of the present invention will be described in detail based on the following figures, wherein:

FIG. 1 illustrates apparatuses according to an exemplary embodiment of the present invention;

FIG. 2 illustrates the hardware configuration of an image forming apparatus;

FIG. 3 illustrates an example of processing identifiers;

FIG. 4 illustrates functions implemented in the exemplary embodiment of the present invention;

FIG. 5 illustrates the hardware configuration of a relay apparatus;

FIG. 6 illustrates the hardware configuration of an information processing apparatus;

FIG. 7 illustrates an example of processing performed by the information processing apparatus;

FIG. 8 illustrates the hardware configuration of an information storage apparatus;

FIG. 9 describes a first exemplary operation performed in the exemplary embodiment;

FIGS. 10A and 10B illustrate an example of screens displayed in a terminal apparatus;

FIG. 11 illustrates an example of a screen displayed in the terminal apparatus;

FIG. 12 describes a second exemplary operation performed in the exemplary embodiment;

FIG. 13 illustrates an example of a screen displayed in the terminal apparatus;

FIG. 14 describes a third exemplary operation performed in the exemplary embodiment; and

FIG. 15 illustrates an example of a screen displayed in the terminal apparatus.

### DETAILED DESCRIPTION

### Exemplary Embodiment

### Overall Configuration

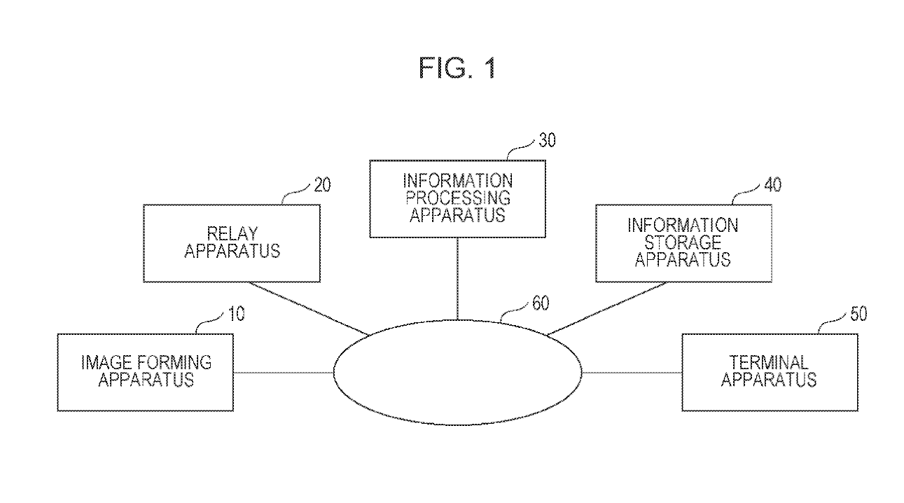

FIG. 1 illustrates apparatuses according to an exemplary embodiment of the present invention. Regarding each apparatus illustrated in FIG. 1, the number of apparatuses is not limited to one and multiple apparatuses may be provided.

A communication line 60, e.g., the Internet, connects computer apparatuses that are connected thereto to one another. Note that the communication line 60 is not limited to the Internet and may be a local area network (LAN), a telephone network, a mobile communication network, or the like.

An image forming apparatus 10 is an apparatus having functions, such as an authentication function of authenticating a user, a copy function of copying a document, a scan function of optically reading a document and generating image data which is an example of information representing an image of the read document, an image forming function of forming an image represented by data transmitted from another computer apparatus on a sheet, a communication function of performing communication with another computer apparatus via the communication line 60, and a function of instructing another computer apparatus to process information.

A relay apparatus 20 is a computer apparatus having a function of transferring information transmitted from an apparatus to another apparatus, such as transferring information transmitted from the image forming apparatus 10 to an information processing apparatus 30 and transferring information transmitted from the information processing apparatus 30 to an information storage apparatus 40.

The information processing apparatus 30 is a computer apparatus that provides a service of performing various kinds of processing on obtained information and outputting the processed information. The information processing apparatus 30 has a function of calculating a time period taken for processing obtained information and outputting the calculated time period.

The information storage apparatus 40 is a computer apparatus that stores various pieces of information transmitted from the relay apparatus 20. The information storage apparatus 40 has a function of providing a list of pieces of stored information to another computer apparatus and a function of providing stored information to another computer apparatus.

A terminal apparatus 50 is a computer apparatus that performs communication with another computer apparatus via the communication line 60. In this exemplary embodiment, the terminal apparatus 50 is a tablet terminal. Note that the terminal apparatus 50 is not limited to the tablet terminal and may be another type of computer apparatus, such as a personal computer or smartphone, which performs communication with another computer apparatus via the communication line 60. The terminal apparatus 50 stores a program implementing a web browser and accesses the information storage apparatus 40 by using the web browser.

In this exemplary embodiment, the relay apparatus 20 and the information processing apparatus 30 operate in cooperation with each other to function as a communication system. The communication system may additionally include the information storage apparatus 40 and may further include the image forming apparatus 10.

### Configuration of Image Forming Apparatus 10

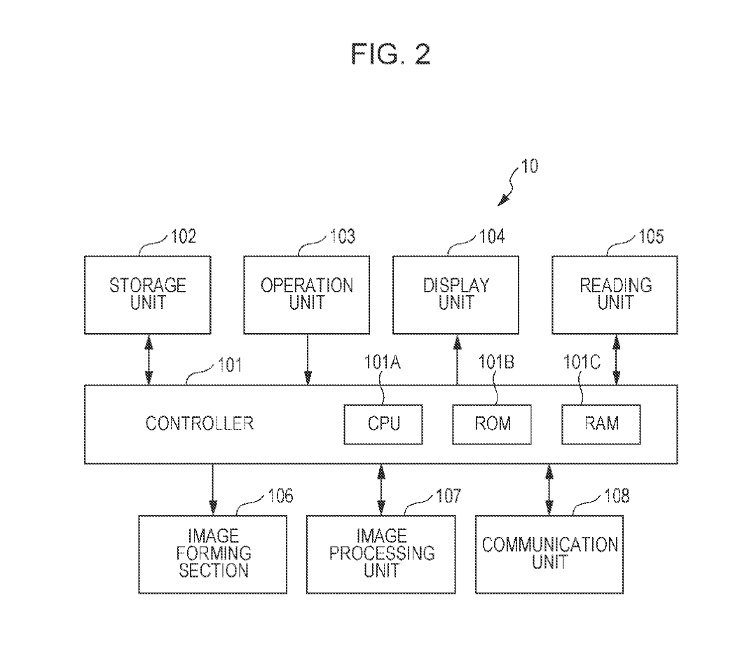

FIG. 2 is a block diagram illustrating the hardware configuration of the image forming apparatus 10. A display unit 104 includes a display device and displays operation screens and menu screens used to operate the image forming apparatus 10. An operation unit 103 includes multiple buttons used to operate the image forming apparatus 10 and a transparent pointing device provided on the surface of the display unit 104. The display device of the display unit 104 and the pointing device of the operation unit 103 operate in cooperation with each other to function as a touch screen. The image forming apparatus 10 operates in accordance with an operation performed on the buttons and the touch screen. A communication unit 108 is connected to the communication line 60 through a communication cable and performs communication with another apparatus connected to the communication line 60.

A reading unit 105 includes an image reading apparatus (not illustrated) that optically reads characters, figures, and so forth formed on a sheet and that generates image data representing the read image. The image data generated by the reading unit 105 is stored in a storage unit 102. An image processing unit 107 performs image processing, such as color correction and gradation correction, on image data supplied from the storage unit 102. The processed image data is supplied to an image forming section 106 or the storage unit 102.

The image forming section 106 forms toner images on a sheet by using the electrophotographic system. Specifically, the image forming section 106 includes image forming units, each of which forms a corresponding one of toner images of yellow (Y), magenta (M), cyan (C), and a key tone (black in this exemplary embodiment) on a sheet. When an image is formed on a sheet, image data that has been processed by the image processing unit 107 is supplied to the image forming section 106. Based on the supplied image data, the image forming section 106 forms images on a sheet using the image forming units. Although the image forming section 106 of this exemplary embodiment is configured to form a color image with toners of multiple colors, the image forming section 106 may be configured not to include the image forming units that form toner images of Y, M, and C and may be configured to form a black-and-white image. Also, although an image is formed on a sheet with toner in this exemplary embodiment, an image may be formed on a sheet with ink as in the inkjet system or the like.

The storage unit 102 includes a storage device (for example, a hard disk drive) that holds data even when power is not supplied thereto. The storage unit 102 stores image data generated by the reading unit 105 and user identifiers and passwords which are used to identify users who are permitted to use the image forming apparatus 10.

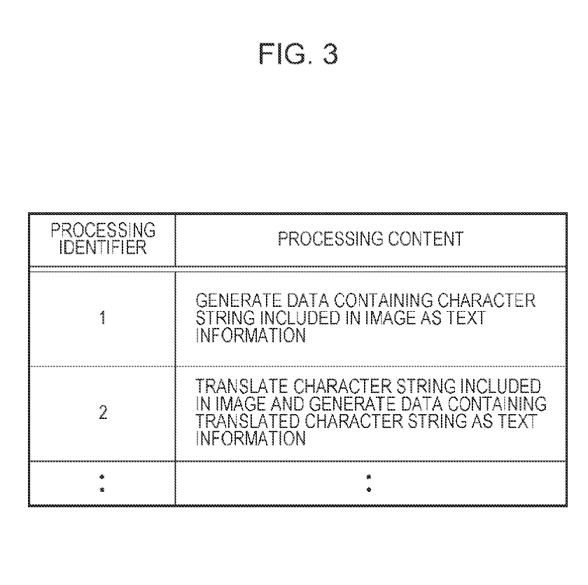

The storage unit 102 also stores processing identifiers each of which identifies corresponding processing content that is specified when the information processing apparatus 30 is instructed to perform processing on information (image data in this exemplary embodiment). FIG. 3 illustrates an example of the processing identifiers stored in the storage unit 102. In this exemplary embodiment, for example, a processing identifier “1” represents processing of recognizing a character string included in an image represented by image data and generating data containing the recognized character string as text information. Also, for example, a processing identifier “2” represents processing of translating a character string included in an image represented by image data into another language (for example, English) and generating data containing the translated character string as text information.

A controller 101 includes a central processing unit (CPU) 101A, a read only memory (ROM) 101B, and a random access memory (RAM) 101C. The ROM 101B stores programs that implement the above-described functions, such as the authentication function, the copy function, the scan function, the image forming function, the communication function, and the function of instructing the information processing apparatus 30 to process information. The various functions described above are implemented as a result of the CPU 101A executing the programs stored in the ROM 101B.

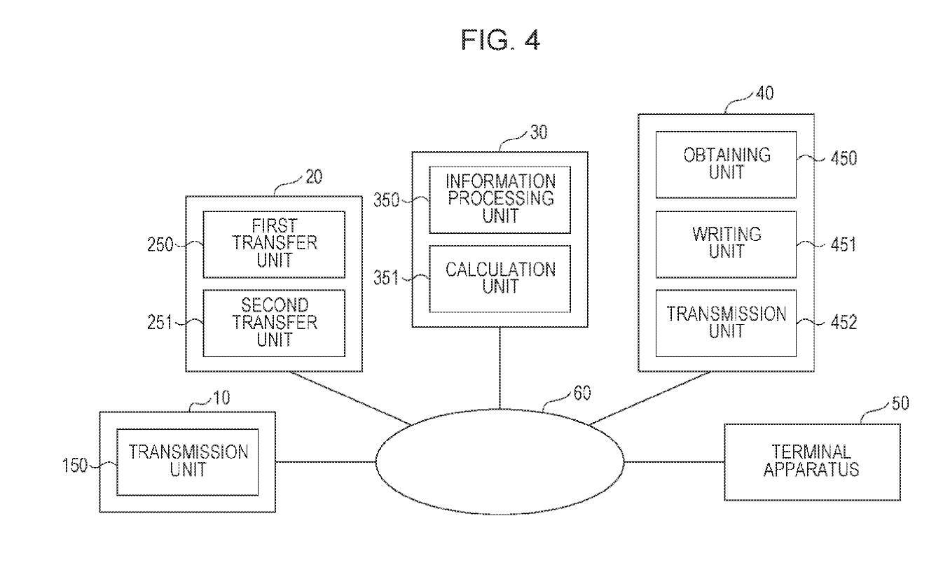

FIG. 4 is a functional block diagram illustrating characteristic functions according to this exemplary embodiment, among functions implemented in this exemplary embodiment. As illustrated in FIG. 4, in the image forming apparatus 10, a transmission unit 150 is implemented as a result of the CPU 101A executing the programs. The transmission unit 150 has a function of transmitting information to be processed by the information processing apparatus 30 to the relay apparatus 20 by controlling the communication unit 108.

### Configuration of Relay Apparatus 20

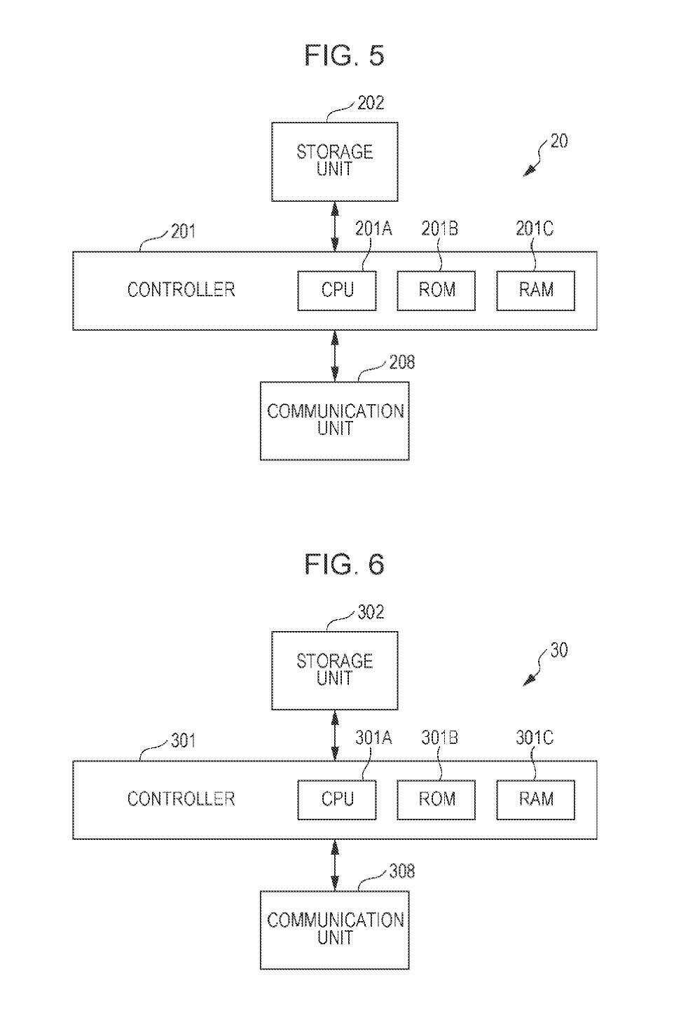

FIG. 5 is a block diagram illustrating the hardware configuration of the relay apparatus 20. A communication unit 208 is connected to the communication line 60 through a communication cable and performs communication with another apparatus connected to the communication line 60. A storage unit 202 includes a hard disk drive. The storage unit 202 stores programs that implement the operating system and programs that implement the function of transferring information.

A controller 201 includes a CPU 201A, a ROM 201B, and a RAM 201C. Upon the CPU 201A executing an initial program loader (IPL) stored in the ROM 201B, the programs stored in the storage unit 202 are executed, and consequently the above-described functions are implemented.

As illustrated in FIG. 4, a first transfer unit 250 and a second transfer unit 251 are implemented as a result of the CPU 201A executing the programs. The first transfer unit 250 has a function of obtaining information transmitted from the image forming apparatus 10 and transferring the obtained information to the information processing apparatus 30 by controlling the communication unit 208. The second transfer unit 251 has a function of obtaining information (data such as document data and image data, a message, or an estimated time period described later) or the like which is output from the information processing apparatus 30 and transferring the obtained information to the information storage apparatus 40 by controlling the communication unit 208.

### Configuration of Information Processing Apparatus 30

FIG. 6 is a block diagram illustrating the hardware configuration of the information processing apparatus 30. A communication unit 308 is connected to the communication line 60 through a communication cable and performs communication with another apparatus connected to the communication line 60.

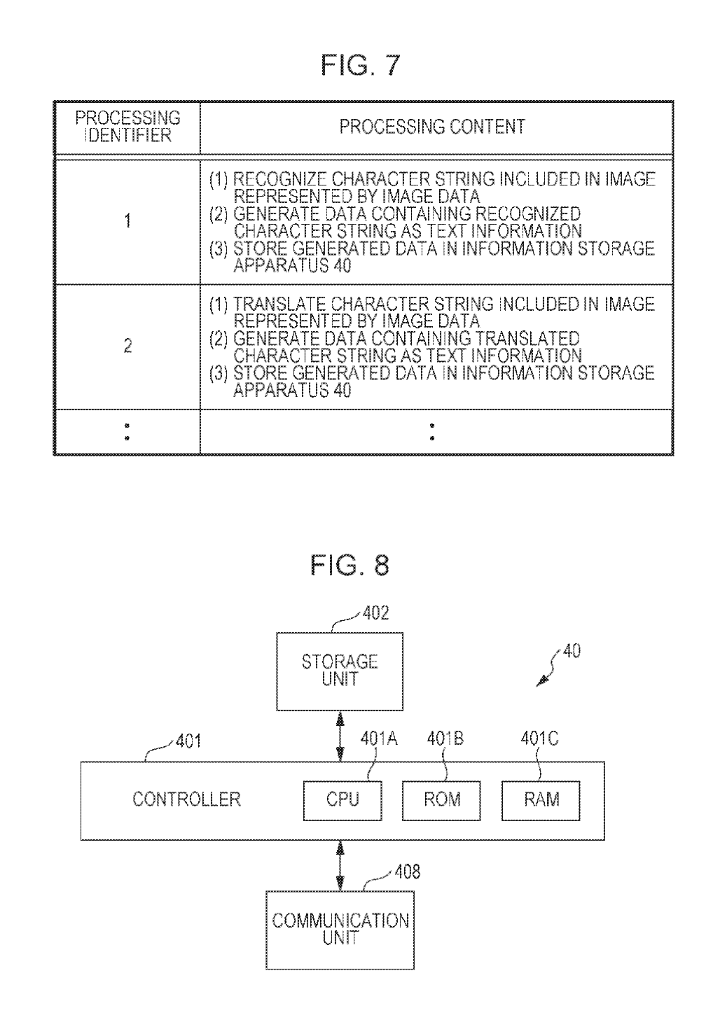

A storage unit 302 includes a hard disk drive. The storage unit 302 stores programs, such as programs that implement the operating system and programs that implement the function of performing various kinds of processing on obtained information and the function of calculating a time period (hereinafter, referred to as an estimated time period) taken for processing obtained information. As illustrated in FIG. 7, the storage unit 302 also stores processing identifiers and contents of processing identified by the corresponding processing identifiers in association with each other.

A controller 301 includes a CPU 301A, a ROM 301B, and a RAM 301C. Upon the CPU 301A executing an IPL stored in the ROM 301B, the programs stored in the storage unit 302 are executed, and consequently the various functions described above are implemented.

FIG. 4 illustrates functions implemented in the information processing apparatus 30 as a result of the CPU 301A executing the programs. In the information processing apparatus 30, an information processing unit 350 and a calculation unit 351 are implemented. The information processing unit 350 has a function of obtaining information transmitted from the relay apparatus 20, performing various kinds of processing on the obtained information, and transmitting the processed information to the relay apparatus 20 by controlling the communication unit 308. Also, the information processing unit 350 has a function of aborting processing if an abnormality occurs during processing of information, and transmitting a message indicating that an abnormality has occurred to the relay apparatus 20 by controlling the communication unit 308. The calculation unit 351 has a function of calculating the estimated time period and transmitting the estimated time period obtained through the calculation to the relay apparatus 20 by controlling the communication unit 308.

### Configuration of Information Storage Apparatus 40

FIG. 8 is a block diagram illustrating the hardware configuration of the information storage apparatus 40. A communication unit 408 is connected to the communication line 60 through a communication cable and performs communication with another apparatus connected to the communication line 60. A storage unit 402 includes a hard disk drive. The storage unit 402 stores programs that implement the operating system and programs that implement the function of storing information transmitted from the relay apparatus 20 therein, the function of providing a web page (hereinafter also referred to as a page) showing a list of pieces of information stored therein, and so forth. A controller 401 includes a CPU 401A, a ROM 401B, and a RAM 401C. Upon the CPU 401A executing an IPL stored in the ROM 401B, the programs stored in the storage unit 402 are executed, and consequently the various functions described above are implemented.

FIG. 4 illustrates functions implemented in the information storage apparatus 40 as a result of the CPU 401A executing the programs. In the information storage apparatus 40, an obtaining unit 450, a writing unit 451, and a transmission unit 452 are implemented.

The obtaining unit 450 has a function of obtaining information transmitted from the relay apparatus 20 by controlling the communication unit 408. The writing unit 451 has a function of writing and storing information obtained by the obtaining unit 450 in the storage unit 402. The transmission unit 452 has a function of transmitting, in response to a request from the terminal apparatus 50, information stored in the storage unit 402 to the terminal apparatus 50 by controlling the communication unit 408.

### First Exemplary Operation in Exemplary Embodiment

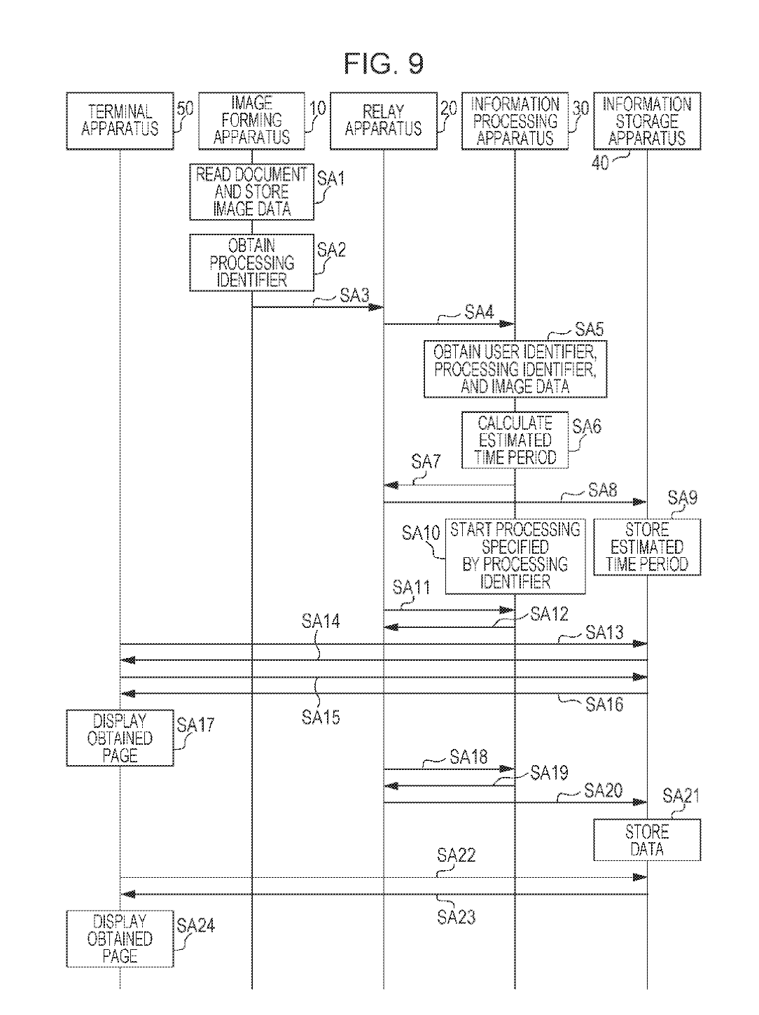

Now, a first exemplary operation performed in this exemplary embodiment will be described using FIG. 9. If a user who is permitted to use the image forming apparatus 10 enters his/her user identifier and password using the operation unit 103, the image forming apparatus 10 determines whether the entered set of the user identifier and the password is stored in the storage unit 102 so as to perform user authentication. If the entered set of the user identifier and the password is stored in the storage unit 102, the image forming apparatus 10 is ready to be used by the user.

The user positions a document at the reading unit 105 of the image forming apparatus 10, and then performs an operation to give a document read instruction and an operation to enter a file name (also referred to as a title) “AAA” to be assigned to a file of image data representing the read image on the operation unit 103. In response to these operations, the image forming apparatus 10 reads an image of the document, generates a file of image data representing the read image, assigns the entered file name to this file, and stores the file in the storage unit 102 (step SA1). Although an example has been described herein in which the user enters a file name to be assigned to a file of image data of the read image, the reading unit 105 may assign, as the file name, a character string including time information representing the date and time at which the document has been read by the reading unit 105, the number uniquely identifying the read operation, the user identifier, the name of the image forming apparatus, and so forth. The user then performs an operation to specify processing to be performed on the stored image data. If the user enters “1” as the processing identifier indicating the processing content using the operation unit 103, the image forming apparatus 10 obtains the entered processing identifier (step SA2). The image forming apparatus 10 (the transmission unit 150) then transmits the user identifier entered during authentication, the obtained processing identifier, and the file of the image data stored in the storage unit 102 to the relay apparatus 20 (step SA3).

The relay apparatus 20 (the first transfer unit 250) obtains the user identifier, the processing identifier, and the file of the image data that have been transmitted in step SA3. The relay apparatus 20 (the first transfer unit 250) transmits the obtained user identifier, processing identifier, and file of the image data to the information processing apparatus 30 (step SA4). The information processing apparatus 30 (the information processing unit 350) obtains the user identifier, the processing identifier, and the file of the image data that have been transmitted in step SA4 (step SA5).

The information processing apparatus 30 identifies processing to be performed on the obtained image data on the basis of the obtained processing identifier. After identifying the processing, the information processing apparatus 30 (the calculation unit 351) calculates the estimated time period taken for the processing identified for the obtained image data (step SA6). The processing identified for the image data may be constituted by a series of processing steps, just like processing which is identified by the processing identifier “1” specified by the user in FIG. 7 and which is constituted by “(1) recognizing a character string included in an image represented by the image data”, “(2) generating data containing the recognized character string as text information”, and “(3) storing the generated data in the information storage apparatus 40”. In such a case, the information processing apparatus 30 calculates estimated time periods taken for the individual processing steps and sums up the results. After finishing calculating the estimated time period, the information processing apparatus 30 generates a temporary document file in which information indicating the obtained estimated time period and the processing state is written. When creating this temporary document file, the information processing apparatus 30 assigns, as the name of this file, a character string “AAA (now processing)” which is obtained by appending a character string “(now processing)” indicating that this image data is now being processed to the file name “AAA” of the file of the obtained image data. The information processing apparatus 30 then transmits this generated temporary document file and the obtained user identifier to the relay apparatus 20 (step SA7). Note that the temporary document file may be generated as a text file in which information regarding the estimated time period up to completion of the processing and the processing state is written. For example, in the case where the estimated time period is three minutes, the temporary document file is generated as a text file containing a character string “processing will be completed in 3 minutes”. Also, a character string representing information regarding the estimated time period and the processing state may be assigned as the file name. This allows the user to know that processing of the image data has not been completed yet or the estimated time period up to completion of the processing of the image data and the processing state by referring to the name or content of this temporary document file.

The relay apparatus 20 (the second transfer unit 251) obtains the user identifier and the temporary document file that have been transmitted in step SA7, and transmits the obtained user identifier and temporary document file to the information storage apparatus 40 (step SA8). The information storage apparatus 40 (the obtaining unit 450) obtains the user identifier and the temporary document file that have been transmitted in step SA8. The information storage apparatus 40 (the writing unit 451) writes and stores the obtained user identifier, the obtained temporary document file, and the time information representing the date and time at which this temporary document file has been obtained, in the storage unit 402 in association with one another (step SA9).

On the other hand, after finishing calculating the estimated time period, the information processing apparatus 30 (the information processing unit 350) starts the processing identified by the processing identifier (step SA10). For example, in the case where the obtained processing identifier is “1”, the information processing apparatus 30 performs the corresponding processing illustrated in FIG. 7. The relay apparatus 20 makes an inquiry to the information processing apparatus 30 as to whether the processing that had been started by the information processing apparatus 30 has ended (step SA11). This inquiry from the relay apparatus 20 to the information processing apparatus 30 may be made periodically at certain intervals or after the estimated time period written in the temporary document file has passed on the basis of the temporary document file obtained from the information processing apparatus 30. If the processing that had been started in step SA10 has not ended, the information processing apparatus 30 notifies the relay apparatus 20 that the processing has not ended, in response to the inquiry from the relay apparatus 20 (step SA12).

If the user performs an operation to access the information storage apparatus 40 on the terminal apparatus 50 at this time, a list of pieces of information (for example, files of document data and image data, and the temporary document file) that are stored in the storage unit 402 in association with the user identifier of the user is transmitted to the terminal apparatus 50. Specifically, the user accesses the information storage apparatus 40 using a web browser in the terminal apparatus 50 (step SA13). The information storage apparatus 40 transmits a page on which the user's user identifier is to be entered to the terminal apparatus 50 (step SA14). The terminal apparatus 50 obtains the page transmitted in step SA14 and displays the obtained page. The user then enters his/her user identifier on the displayed page in the terminal apparatus 50 and performs an operation to transmit the entered user identifier. Then, the terminal apparatus 50 transmits the entered user identifier and a message for requesting a list of pieces of information stored in association with the user identifier, to the information storage apparatus 40 (step SA15). Upon obtaining the user identifier and the message that have been transmitted in step SA15, the information storage apparatus 40 (the transmission unit 452) generates a page showing the list of pieces of information stored in association with the obtained user identifier, and transmits the generated page to the terminal apparatus 50 (step SA16). The page transmitted at this time contains the obtained user identifier. The page transmitted at this time also contains the file name and the storage date and time of the temporary document file because the temporary document file and the storage date and time at which this temporary document file has been stored are stored in association with the user identifier in step SA9 in the information storage apparatus 40.

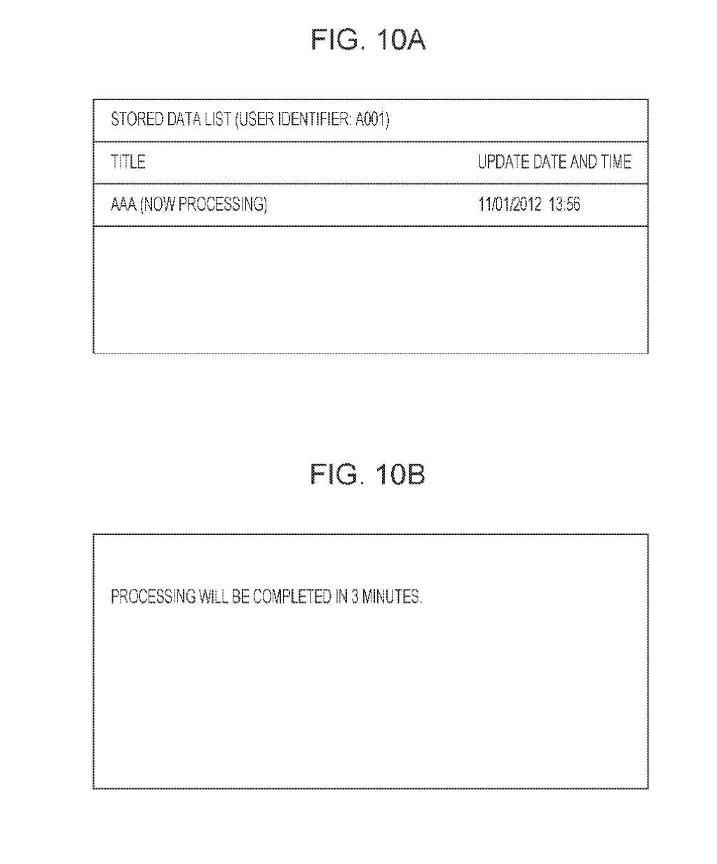

The terminal apparatus 50 obtains the page transmitted in step SA16, and displays the obtained page (step SA17). FIG. 10A illustrates an example of the displayed page. As illustrated in FIG. 10A, the file name “AAA (now processing)” of the temporary document file and the storage date and time at which this temporary document file has been stored are displayed in association with each other in the terminal apparatus 50. This allows the user to recognize that the processing specified in step SA2 is still being performed.

If the user performs an operation to make a request for reference to this temporary document file “AAA (now processing)” on the terminal apparatus 50, the terminal apparatus 50 makes a request for reference to the temporary document file “AAA (now processing)” to the information storage apparatus 40. In response to this reference request, the information storage apparatus 40 generates display information for displaying the content of this temporary document file “AAA (now processing)”, and transmits the generated display information to the terminal apparatus 50. Upon receiving this display information, the terminal apparatus 50 displays the content of the temporary document file “AAA (now processing)” represented by the transmitted display information. Now, suppose that “PROCESSING WILL BE COMPLETED IN 3 MINUTES” is written in the temporary document file “AAA (now processing)” as described above. In this case, a character string “PROCESSING WILL BE COMPLETED IN 3 MINUTES”, which indicates the estimated time period and the processing state, is displayed as illustrated in FIG. 10B.

On the other hand, if the relay apparatus 20 obtains a notification indicating that the processing has not ended in step SA12, the relay apparatus 20 again makes, after a predetermined time period has passed, an inquiry to the information processing apparatus 30 as to whether the processing that had been started by the information processing apparatus 30 has ended (step SA18). When the processing started in step SA10 ends, the information processing apparatus 30 (the information processing unit 350) generates a file of the image data for which the processing has been completed, and transmits the user identifier obtained in step SA4 and the file resulting from the performed processing to the relay apparatus 20 (step SA19).

The relay apparatus 20 (the second transfer unit 251) transmits the user identifier and the file that have been transmitted in step SA19, to the information storage apparatus 40 (step SA20). The information storage apparatus 40 (the obtaining unit 450) obtains the user identifier and the file that have been transmitted in step SA20. The information storage apparatus 40 (the writing unit 451) writes the obtained user identifier, the obtained file, and the time information representing the date and time at which this file has been obtained in the storage unit 402 in association with one another (step SA21).

If the user performs an operation to update the page obtained in step SA16 on the terminal apparatus 50 at this time, the terminal apparatus 50 transmits the user identifier and a message requesting the list to the information storage apparatus 40 as in step SA15 (step SA22). Upon obtaining the message and the user identifier that have been transmitted in step SA22, the information storage apparatus 40 (the transmission unit 452) generates a page showing a list of files stored in association with the obtained user identifier, and transmits the generated page to the terminal apparatus 50 (step SA23).

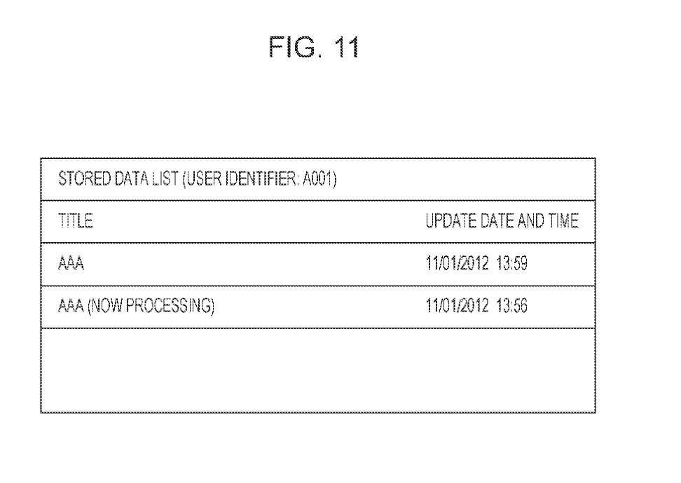

The terminal apparatus 50 obtains the page transmitted in step SA23, and displays the obtained page (step SA24). FIG. 11 illustrates an example of the displayed page. As illustrated in FIG. 11, information representing the file “AAA” that has been generated through the processing specified by the user and information representing the date and time at which the file has been stored are displayed in association with each other in the terminal apparatus 50. This allows the user to confirm that the processing specified in step SA2 has ended and the file resulting from the processing is stored in the information storage apparatus 40. If the user performs an operation to touch the displayed file name on the terminal apparatus 50, the user is able to download or refer to the file identified by the file name, that is, the file stored in step SA21.

### Second Exemplary Operation in Exemplary Embodiment

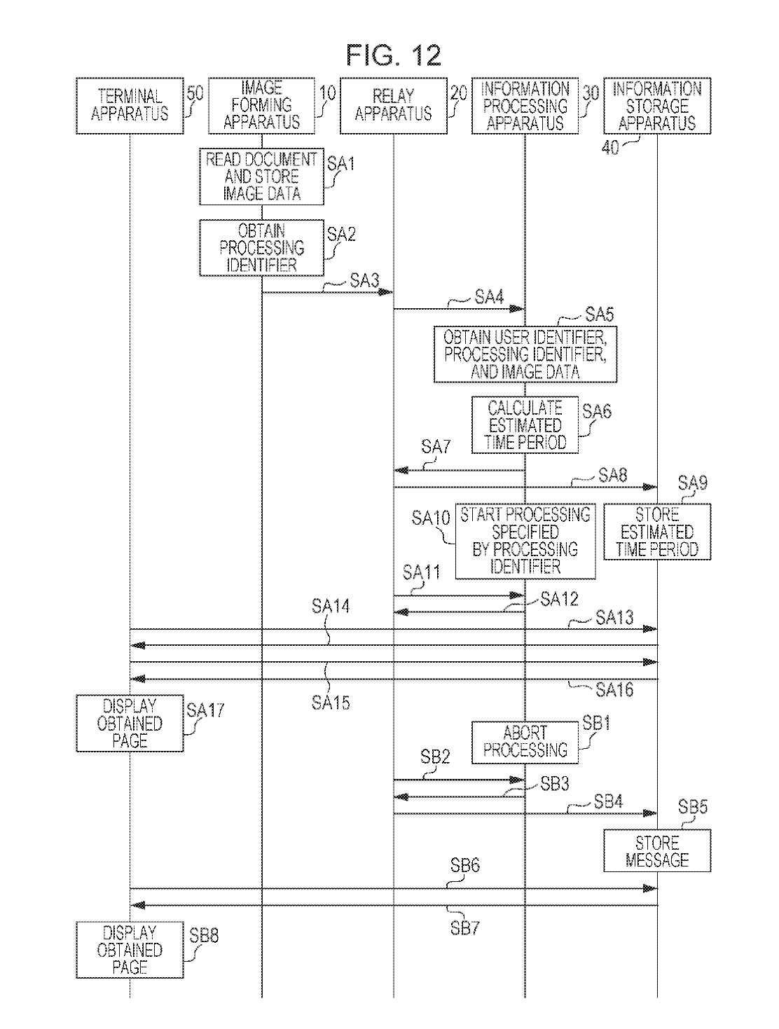

Now, a second exemplary operation performed in this exemplary embodiment will be described using FIG. 12. The second exemplary operation is an example of the operation performed in the case where an abnormality occurs during processing of image data in the information processing apparatus 30. In the second exemplary operation, processing of steps SA1 to SA17 is the same as that of the first exemplary operation but processing of following steps differs from processing of steps following step SA17 of the first exemplary operation. Accordingly, a description of the operation of steps SA1 to SA17 is omitted.

The information processing apparatus 30 (the information processing unit 350) starts processing in step SA10. Thereafter, if an abnormality occurs while the processing is being performed, the information processing apparatus 30 (the information processing unit 350) aborts the processing being performed (step SB1).

If the relay apparatus 20 obtains a notification indicating that the processing has not ended in step SA12, the relay apparatus 20 again makes, after a predetermined time period has passed, an inquiry to the information processing apparatus 30 as to whether the processing that had been started by the information processing apparatus 30 has ended (step SB2). In the case where the processing that had been started in step SA10 has been aborted because of occurrence of an abnormality, the information processing apparatus 30 (the information processing unit 350) transmits the user identifier obtained in step SA5 and a file indicating that the processing has been aborted due to the occurrence of an abnormality to the relay apparatus 20 (step SB3). In the case where the processing being performed has been aborted because an abnormality has occurred during the processing, the information processing apparatus 30 generates a text file and transmits the text file to the relay apparatus 20. The text file has a file name “AAA (processing aborted due to abnormality)” and contains a character string indicating the abnormal state therein. The file name is obtained by appending a character string “(processing aborted due to abnormality)” indicating that the processing has been aborted due to occurrence of an abnormality to the file name “AAA” of the file of the obtained data.

The relay apparatus 20 (the second transfer unit 251) obtains the user identifier and the file that have been transmitted in step SB3, and transmits the obtained user identifier and file to the information storage apparatus 40 (step SB4). The information storage apparatus 40 (the obtaining unit 450) obtains the user identifier and the file that have been transmitted in step SB4. The information storage apparatus 40 (the writing unit 451) writes the obtained user identifier, the obtained file, and the time information representing the date and time at which the file has been obtained in the storage unit 402 in association with one another (step SB5).

If the user performs an operation to update the page obtained in step SA16 on the terminal apparatus 50 at this time, the terminal apparatus 50 transmits the user identifier and a message requesting the list to the information storage apparatus 40 as in step SA15 (step SB6). Upon obtaining the message and the user identifier that have been transmitted in step SB6, the information storage apparatus 40 (the transmission unit 452) generates a page showing the list of files stored in association with the obtained user identifier, and transmits the generated page to the terminal apparatus 50 (step SB7).

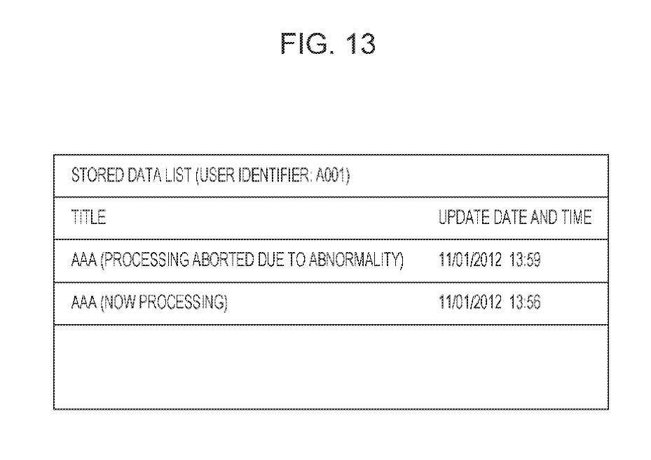

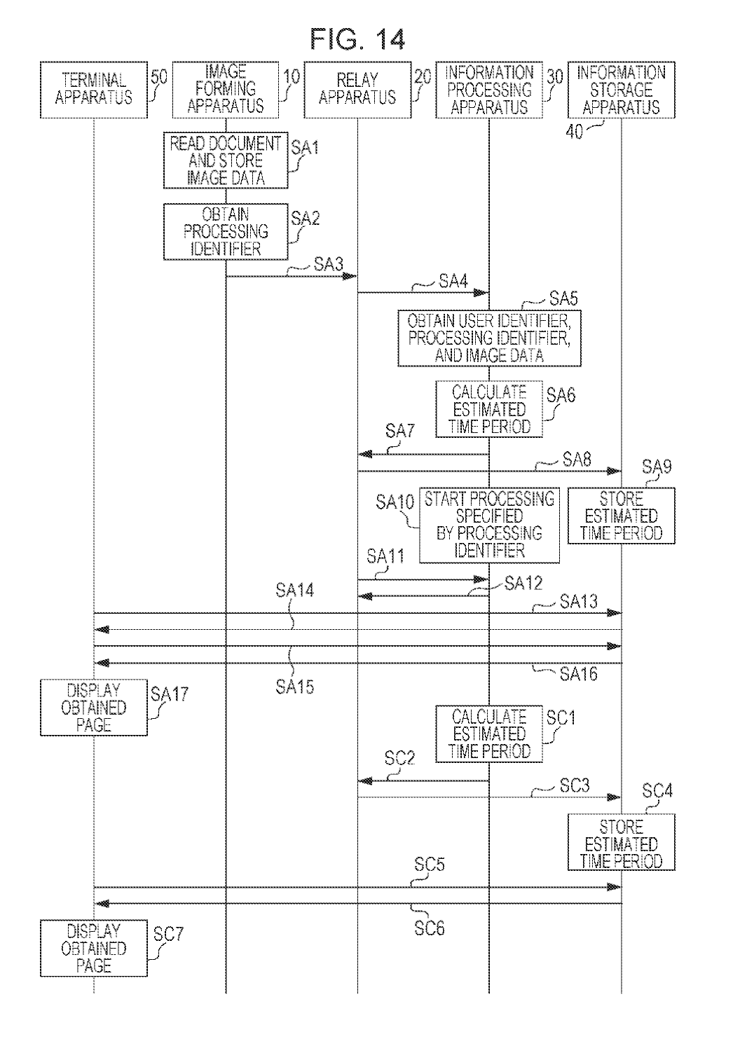

The terminal apparatus 50 obtains the page transmitted in step SB7, and displays the obtained page (step SB8). FIG. 13 illustrates an example of the displayed page. As illustrated in FIG. 13, the file name indicating that an abnormality has occurred during processing of the image data is displayed in the terminal apparatus 50. This allows the user to recognize that the processing specified in step SA2 has been aborted due to the occurrence of an abnormality.

### Third Exemplary Operation in Exemplary Embodiment

Now, a third exemplary operation performed in this exemplary embodiment will be described. The third exemplary operation is an example of the operation performed in the case where a time period up to the end of the processing performed by the information processing apparatus 30 exceeds the estimated time period. In the third exemplary operation, processing of steps SA1 to SA17 is the same as that of the first exemplary operation but processing of the following steps differs from processing of steps following step SA17 of the first exemplary operation. Accordingly, a description of the operation of steps SA1 to SA17 is omitted.

The information processing apparatus 30 starts processing in step SA10. Thereafter, if the processing has not ended when the estimated time period calculated in step SA6 has passed, the information processing apparatus 30 (the calculation unit 351) re-calculates the estimated time period up to the end of the processing being performed (step SC1). After finishing re-calculating the estimated time period, the information processing apparatus 30 (the calculation unit 351) transmits the user identifier obtained in step SA4 and a temporary document file having a file name including the estimated time period re-calculated in step SC1 to the relay apparatus 20 (step SC2).

The relay apparatus 20 (the second transfer unit 251) transmits the user identifier and the temporary document file that have been transmitted in step SC2, to the information storage apparatus 40 (step SC3). The information storage apparatus 40 (the obtaining unit 450) obtains the user identifier and the temporary document file that have been transmitted in step SC3. The information storage apparatus 40 (the writing unit 451) writes the obtained user identifier, the temporary document file, and the time information representing the date and time at which this temporary document file has been obtained in the storage unit 402 in association with one another (step SC4).

If the user performs an operation to update the page obtained in step SA16 on the terminal apparatus 50 at this time, the terminal apparatus 50 transmits the user identifier and a message requesting the list to the information storage apparatus 40 as in step SA15 (step SC5). Upon obtaining the message and the user identifier that have been transmitted in step SC5, the information storage apparatus 40 (the transmission unit 452) generates a page showing the list of pieces of information stored in association with the obtained user identifier, and transmits the generated page to the terminal apparatus 50 (step SC6).

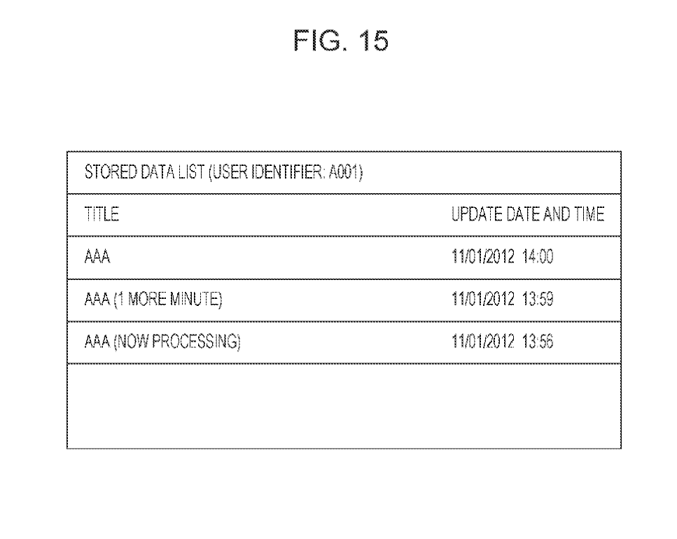

The terminal apparatus 50 obtains the page transmitted in step SC6, and displays the obtained page (step SC7). FIG. 15 illustrates an example of the displayed page. As illustrated in FIG. 15, the re-calculated estimated time period is displayed in the terminal apparatus 50. This allows the user to confirm the time at which the processing specified in step SA2 will end.

### MODIFICATIONS

While the exemplary embodiment of the present invention has been described above, the present invention is not limited to the above-described exemplary embodiment and may be carried out in various other configurations. For example, the present invention may be carried out by modifying the above-described exemplary embodiment in the following manner. Note that the exemplary embodiment described above and modifications described below may be variously combined.

In the above-described exemplary embodiment, the terminal apparatus 50 obtains the page showing the list from the information storage apparatus 40 and the displays the page. However, the image forming apparatus 10 may obtain and display the page showing the list.

In the above-described exemplary embodiment, the information processing apparatus 30 processes image data, which is an example of information. However, information to be processed is not limited to image data. Information to be processed by the information processing apparatus 30 may be other kinds of information, for example, text data, movie data, and audio data.

In the present invention, the apparatus that gives an instruction to process image data is not limited to the image forming apparatus 10 and may be another type of computer apparatus, such as a personal computer, smartphone, or tablet computer.

In the above-described exemplary embodiment, the information processing apparatus 30 processes image data in accordance with the processing identifier obtained together with the image data. However, the information processing apparatus 30 may be configured to perform one kind of processing, and multiple information processing apparatuses 30 may be provided for corresponding kinds of processing. In the case of this configuration, if the processing identifier obtained together with the image data from the image forming apparatus 10 is “1”, the relay apparatus 20 may be configured to transmit the image data to the first information processing apparatus 30 that performs processing corresponding to this processing identifier. If the processing identifier obtained together with the image data from the image forming apparatus 10 is “2”, the relay apparatus 20 may be configured to transmit the image data to the second information processing apparatus 30 that performs processing corresponding to this processing identifier.

In the above-described exemplary embodiment, the information processing apparatus 30 generates a file as information representing the estimated time period and the processing state, writes the information representing the estimated time period and the processing state as the file name or the content of the file, and stores the generated file in the information storage apparatus 40 via the relay apparatus 20. However, the configuration is not limited to this one. For example, the information processing apparatus 30 may generate the information representing the estimated time period and the processing state as a message, and may transmit this message to the information storage apparatus 40 via the relay apparatus 20. The information storage apparatus 40 may manage the received message, and causes a list of messages to be displayed in response to a reference request from the terminal apparatus 50.

In the above-described exemplary embodiment, the information processing apparatus 30 may be a server apparatus that provides a cloud service and the relay apparatus 20 may be a server apparatus that mediates between multiple cloud services.

The above-described programs may be provided after being stored on a computer-readable recording medium, such as a magnetic recording medium (such as a magnetic tape, a magnetic disk (such as a hard disk drive) or a flexible disk (FD)); an optical recording medium (such as an optical disc); a magneto-optical recording medium; or a semiconductor memory, and may be installed into the corresponding apparatuses. Alternatively, the programs may be downloaded and installed into the corresponding apparatuses via the communication line 60.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication system comprising:
an information processing apparatus; and
a relay apparatus,
the information processing apparatus generating, when performing processing on first information which has been obtained, second information and transmitting the generated second information to the relay apparatus, the second information representing an estimated time period taken for processing the first information or a processing state of the first information, and
the relay apparatus obtaining the second information which has been transmitted by the information processing apparatus and outputting the obtained second information to a predetermined information storage apparatus.

2. The communication system according to claim 1, wherein
the relay apparatus makes an inquiry as to whether the processing performed on the first information by the information processing apparatus has ended, on the basis of the estimated time period represented by the obtained second information, and
in a case where the processing performed on the first information has ended in the information processing apparatus, the relay apparatus obtains third information resulting from the processing from the information processing apparatus and outputs the obtained third information to the predetermined information storage apparatus.

3. The communication system according to claim 1, wherein
in a case where the processing performed on the first information has not ended within the estimated time period, the information processing apparatus re-calculates the estimated time period taken for processing the first information, generates the second information representing the re-calculated estimated time period, and transmits the second information to the relay apparatus, and
the relay apparatus obtains the second information representing the re-calculated estimated time period and outputs the obtained second information to the predetermined information storage apparatus.

4. The communication system according to claim 2, wherein
in a case where the processing performed on the first information has not ended within the estimated time period, the information processing apparatus re-calculates the estimated time period taken for processing the first information, generates the second information representing the re-calculated estimated time period, and transmits the second information to the relay apparatus, and
the relay apparatus obtains the second information representing the re-calculated estimated time period and outputs the obtained second information to the predetermined information storage apparatus.

5. An information processing apparatus comprising:
a transmission unit that generates, when processing is performed on first information which has been obtained, second information and that transmits the generated second information to a relay apparatus which outputs the second information to an information storage apparatus, the second information representing an estimated time period taken for processing the first information or a processing state of the first information.

6. A non-transitory computer readable medium storing a program causing a computer to execute a process, the process comprising:
generating, when processing is performed on first information which has been obtained, second information representing at least an estimated time period taken for processing the first information or a processing state of the first information; and
transmitting the generated second information to a relay apparatus which outputs the second information to an information storage apparatus.
